(19) United States
(12) Patent Application Publication
(10) Pub. No.: US 2023/0329974 A1
(43) Pub. Date: Oct. 19, 2023

(54) FLUID TRANSFER SYSTEM

(71) Applicant: ARAN RESEARCH DEVELOPMENT AND PROTOTYPES, Caesarea (IL)

(72) Inventor: Yaron Cina, Sharona (IL)

(73) Assignee: Aran Research Development and Prototypes Ltd., Caesarea (IL)

(21) Appl. No.: 17/787,368

(22) PCT Filed: Dec. 2, 2020
(86) PCT No.: PCT/IB2020/061391

§ 371 Date: Jun. 20, 2022

Related U.S. Application Data
(60) Provisional application No. 62/943,279, filed on Dec. 4, 2019.

(51) Int. Cl. A61J 1/22; A61J 3/00; A61J 1/10; A61J 1/20

(52) U.S. Cl. CPC A61J 1/22; A61J 3/002; A61J 1/10; A61J 1/2089; A61J 2200/74

(57) ABSTRACT

A fluid transfer system (10) includes a sealed chamber (12), a pump (16) in fluid communication with the chamber (12) and configured to pump fluid to the chamber (12) and to draw fluid from the chamber (12), and a sensor (70) configured to sense a weight of contents of the chamber (12).

### FIELD OF THE INVENTION

The present invention relates generally to fluid transfer devices between receptacles, and particularly to a closed-system fluid transfer system that uses pressure to transfer fluid between two receptacles, such as from a vial to a bag or syringe, without any toxic or non-desirable substances leaking to the ambient.

### BACKGROUND OF THE INVENTION

When preparing and administering drugs care has be taken to minimize or preferably eliminate the risk of exposing people, such as medical and pharmacological personnel, to toxic substances. Transferring a liquid medicinal substance from a vial to a bag or syringe requires care to keep the substance free of contamination and to ensure that no toxic or non-desirable substances leak to the ambient.

### SUMMARY OF THE INVENTION

The present invention seeks to provide a fluid transfer system with a pump, as is described more in detail hereinbelow.

There is provided in accordance with an embodiment of the invention a fluid transfer system including a sealed chamber, a pump in fluid communication with the chamber and configured to pump fluid to the chamber and to draw fluid from the chamber, and a sensor configured to sense a weight of contents of the chamber.

A bag may be located in the chamber. The bag may have a port that extends in a sealed manner through the chamber. The port may be connected to a fluid connector which is in fluid communication with a vial adaptor connected to a vial.

In accordance with an embodiment of the invention another sensor is configured to sense a weight of contents of the vial.

In accordance with an embodiment of the invention a vial manipulator is configured to rotate the vial from an upright position to an inverted position.

In accordance with an embodiment of the invention a pressure sensor is coupled to the pump.

### BRIEF DESCRIPTION OF THE DRAWINGS

The present invention will be understood and appreciated more fully from the following detailed description taken in conjunction with the drawings in which:

FIG. 1 is a simplified pictorial illustration of a fluid transfer system, constructed and operative in accordance with a non-limiting embodiment of the present invention, being used for reconstitution of a medical substance;

FIG. 2 is a simplified pictorial illustration of the fluid transfer system of FIG. 1 being used for drawing the medical substance.

FIG. 3 is a simplified pictorial illustration of a fluid transfer system that uses an air pump, constructed and operative in accordance with a non-limiting embodiment of the present invention, being used for reconstitution of a medical substance; and

FIG. 4 is a simplified pictorial illustration of the fluid transfer system of FIG. 3 being used for drawing the medical substance.

### DETAILED DESCRIPTION OF EMBODIMENTS

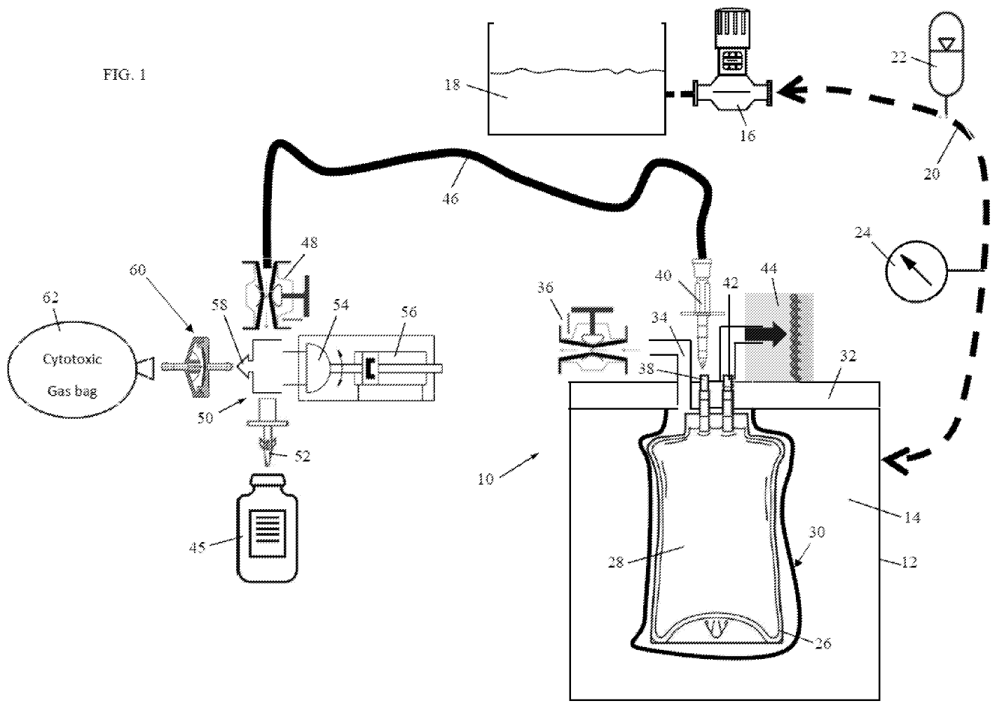

Reference is now made to FIG. 1, which illustrates a fluid transfer system 10, constructed and operative in accordance with a non-limiting embodiment of the present invention.

System 10 includes a chamber 12 at least partially filled with a fluid 14, such as a liquid (e.g., water or oil or other) or a gas (e.g., air or CO₂ or other). The fluid 14 is supplied to chamber 12 by a two-way pump 16 which is in fluid communication with a fluid reservoir 18 (that is, liquid or gas reservoir). Pump 16 can either pump fluid to chamber 12 (positive pressure) or draw fluid from chamber 12 (negative pressure; suction). Tubing 20 connects pump 16 to chamber 12. A sensor 22 may be coupled to tubing 20, which senses the fluid quantity pumped out of (or into) reservoir 18. A pressure sensor 24 may be coupled to tubing 20, which senses the fluid pressure (positive or negative).

A bag 26 containing a liquid 28 (such as saline solution or other liquid) is placed in a sleeve 30 located in chamber 12. Chamber 12 may be sealed by a grommet 32. A bleed port 34 is in fluid communication with the inner volume of sleeve 30 and may be connected to a chamber bleeding valve 36.

The bag 26 may have two ports that extend in a sealed manner through grommet 32. A first port 38 may be connected to a fluid connector 40 (e.g., a bag spike). A second port 42 may be connected to a bag bleeding membrane kit (or valve) 44. The fluid connector 40 is part of a vial adaptor system, which can be any kind of vial adaptor system for effecting fluid transfer between a vial 45 and bag 26 (for reconstitution or drawing, as described below).

The pump 16 may be any kind of suitable pump, such as but not limited to, a peristaltic pump, a dosing pump, a reciprocating pump, centrifugal pump, and many others.

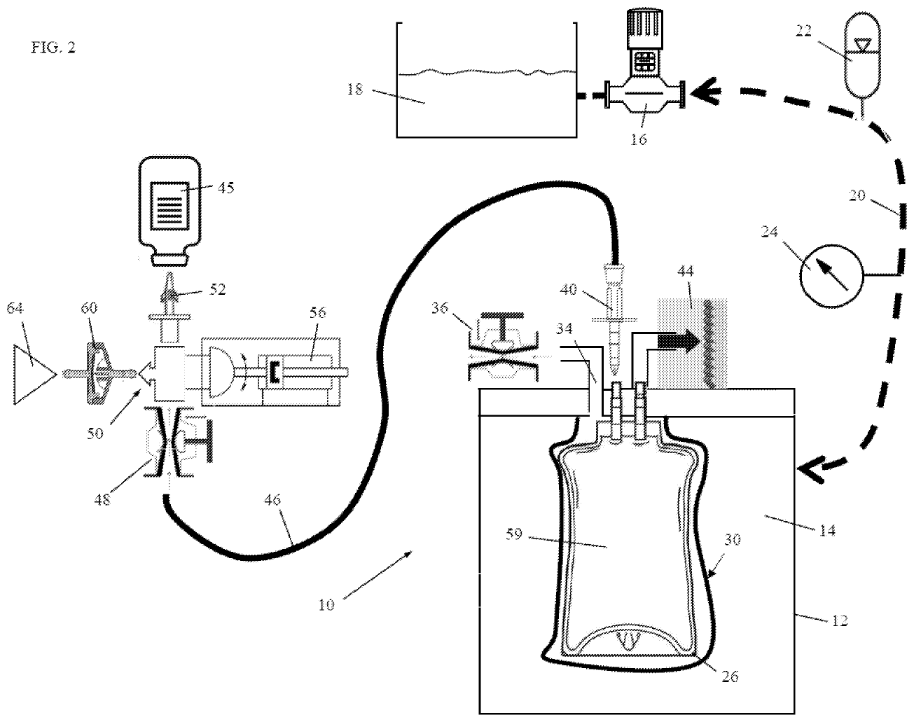

The fluid connector 40 may be connected by tubing 46 to a valve 48 (e.g., a pinch valve), which is in fluid communication with a vial adaptor 50. Vial adaptor 50 may have a vial connector 52 (such as a spike connector) for connecting to vial 45 (such as by piercing a septum of vial 45). Vial adaptor 50 may have an interface portion 54 which is coupled to a vial manipulator 56 (e.g., a swivel actuator and the like), which can rotate vial 45 from an upright position (FIG. 1) to an inverted position (FIG. 2). Vial adaptor 50 may have a port 58 which can be coupled to a one-way valve 60, which can be coupled to a cytotoxic gas bag 62 (FIG. 1) or a microbial filter 64 (FIG. 2). In this manner, any harmful vapors or powder and the like cannot escape to the outside environment, thereby ensuring that reconstitution and drawing are done completely in a sterile manner. It is noted that for reconstitution, instead of using cytotoxic gas bag 62, the vial and vial adaptor can all be placed in a closed chamber, which is at a pressure below the ambient pressure, and which has an active charcoal filter or equivalent filtration system for preventing release of toxic gases to the environment. The tubing 36 may pass into the chamber through a sealed connector.

The following is a method of using the system 10 for reconstitution (FIG. 1).

First, there is identification that the correct vial 45 and (saline) bag 26 are being used. The identification may be done by personnel or may be done by the system, such as by optical readers (e.g., bar code or Q-code, etc.). Then fluid connector 40 with tubing 46 is connected to bag 26 (first use only), and bag 26 is inserted in inner sleeve 30 of chamber 12. Bag 26 is then connected to bag bleeding membrane kit 44.

Valve 48 is connected to vial adaptor 50, and vial adaptor 50 is connected to vial 45 and vial manipulator 56.

The next step is to prime the inner sleeve 30. This may be done by using pump 16 to provide positive pressure and pump fluid 14 from reservoir 18 to fill chamber 12, with valve 36 is open to allow air to escape out of inner sleeve 30. When all air has been forced out of inner sleeve 30, a steep pressure increase of the pumping pressure will be detected by pressure sensor 24 to indicate that the sleeve bleeding is complete. Then the air-exit-port valve 36 is closed and the pumping is stopped. The pressure sensor 24 may be now calibrated to zero.

The next step is to reconstitute the powder or other substance contained in vial 45. The valve 48 is opened and liquid 28 is pumped from bag 26 by using pump 16 (with positive pressure) to pump more fluid 14 from reservoir 18 to chamber 12, thereby squeezing bag 26 to cause the liquid 28 to flow to vial 45. The amount of fluid 14 that is pumped from reservoir 18 to chamber 12 equals the amount of liquid 28 that exits bag 26 to vial 45 if the fluid is liquid. If the fluid is gas, then the volume of gas may not be equal to the volume of liquid 28, depending on the pressure. However, the information from sensor 22 and pressure sensor 24 can be used to correlate the volume of gas to the volume of liquid 28. This amount of fluid 14 may be monitored continuously by sensor 22, thereby monitoring the dosage of liquid 28 to vial 45. The valve 48 may be closed when the dosing is complete. Afterwards, the vial 45 may be shaken (e.g., rotated back and forth) by vial manipulator 56 to complete the reconstitution.

Afterwards, the custom tubing 46 may be disconnected from vial adaptor 50. The vial adaptor 50 may remain connected to vial 45 and the custom tubing 46 may remain connected to bag 26. It is noted that any liquid or dead volume remaining in tubing 46 may be drawn to bag 26 by appropriate application of pressure.

The following is a method of using the system 10 for drawing (FIG. 2).

First, as with reconstitution, there is identification that the correct vial 45 and (saline) bag 26 are being used. The identification may be done by personnel or may be done by the system, such as by optical readers (e.g., bar code or Q-code, etc.). Then fluid connector 40 with tubing 46 is connected to bag 26 (first use only), and bag 26 is inserted in inner sleeve 30 of chamber 12. Bag 26 is then connected to bag bleeding membrane kit 44.

Valve 48 is connected to vial adaptor 50, and vial adaptor 50 is connected to vial 45 and vial manipulator 56.

As done with reconstitution, the next step is to prime the inner sleeve 30. This may be done by using pump 16 to provide positive pressure and pump fluid 14 from reservoir 18 to fill chamber 12, with valve 36 is open to allow air to escape out of inner sleeve 30. When all air has been forced out of inner sleeve 30, a steep pressure increase of the pumping pressure will be detected by pressure sensor 24 to indicate that the sleeve bleeding is complete. Then the air-exit-port valve 36 is closed and the pumping is stopped. The pressure sensor 24 may be now calibrated to zero.

The next step is to draw a liquid substance 59 contained in vial 45 from vial 45 to bag 26. The vial 45 may be first inverted by vial manipulator 56. The valve 48 is opened and fluid 14 is pumped from chamber 12 to reservoir 18 by using pump 16 with negative pressure (suction), thereby causing the liquid substance 59 to flow from vial 45 to bag 26. The amount of fluid 14 that is pumped from chamber 12 to reservoir 18 equals the amount of liquid substance 59 that exits vial 45 and flows to bag 26 (if the fluid is a liquid; if it is a gas then it can be correlated as above). This amount of liquid substance 59 may be monitored continuously by sensor 22, thereby monitoring the dosage of the liquid substance 59 to bag 26. The valve 48 may be closed when the drawing is complete.

Afterwards, the custom tubing 46 may be disconnected from vial adaptor 50. The vial adaptor 50 may remain connected to vial 45 for the next reconstitution or other purpose.

The bag 26 may be released by opening the chamber bleeding valve 36 and pumping fluid 14 from the pressure chamber 12 to the reservoir 18 for a sufficient time to release the pressure on bag 26. The pumping is then stopped and the grommet 32 is opened to gain access to remove bag 26 from the inner sleeve 30 and chamber 12.

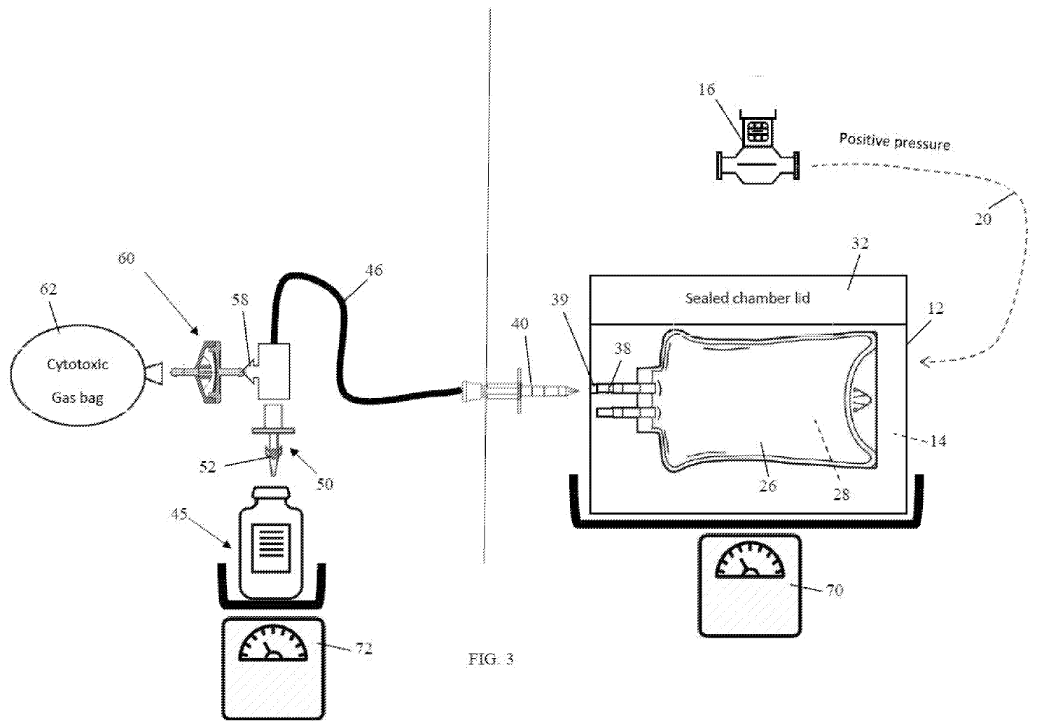

Reference is now made to FIG. 3, which illustrates a fluid transfer system that uses pump 16 as an air pump (or any other gas pump), constructed and operative in accordance with a non-limiting embodiment of the present invention. This embodiment is a preferred and simplified version of the fluid transfer system of FIG. 1; like elements are designated by like numerals. This embodiment may optionally use pressure sensor 24, too.

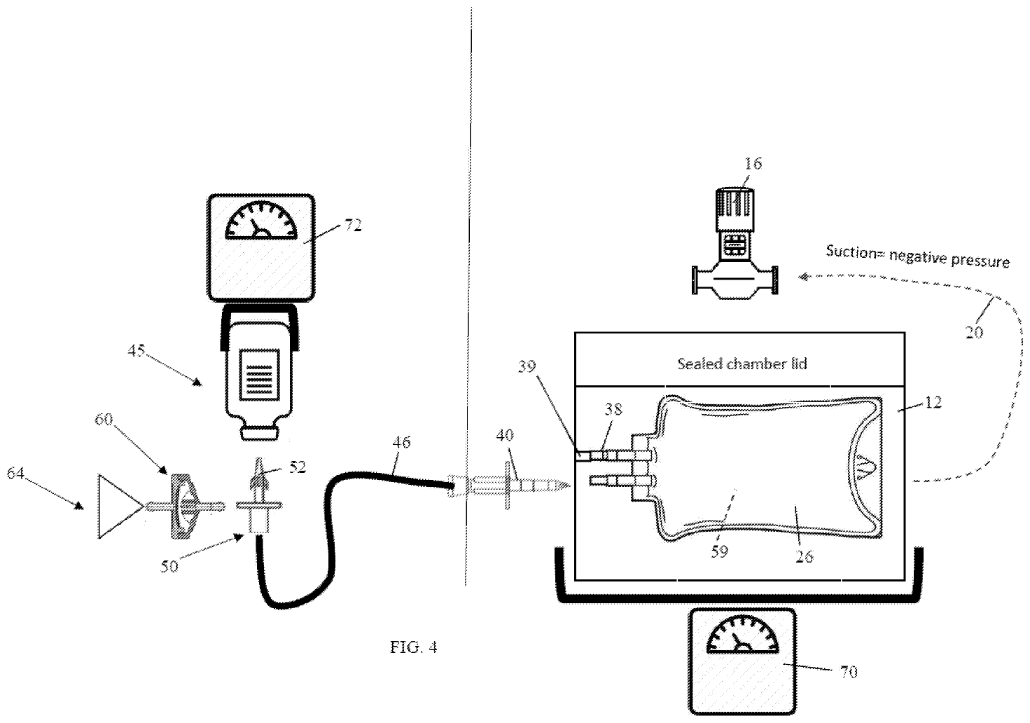

In the embodiment of FIG. 3, as in the previous embodiment, fluid connector 40 with tubing 46 is connected to bag 26 such as via a fluid connector 39 coupled to port 38 (connector 39 is sealed with respect to chamber 12). However, in contrast with the previous embodiment, in this embodiment there is no sleeve. Rather during reconstitution, the positive pressure of the air introduced into the sealed chamber 12 forces the contents (liquid 28) of bag 26 to flow to the vial 45. As opposed to the previous embodiment, in this embodiment, a bag weight sensor 70 (e.g., a load cell) is used to weigh the bag 26 and liquid 28, and a vial weight sensor 72 (e.g., a load cell) is used to weigh the vial 45. In this manner, the vial weight sensor 72 can accurately measure and monitor the dosage of liquid 28 to vial 45 during reconstitution and bag weight sensor 70 can accurately measure and monitor the dosage of the liquid substance 59 to bag 26 during drawing (FIG. 4).

What is claimed is:

1. A fluid transfer system (10) comprising:
a sealed chamber (12);
a pump (16) in fluid communication with said chamber (12) and configured to pump fluid to said chamber (12) and to draw fluid from said chamber (12); and
a sensor (70) configured to sense a weight of contents of said chamber (12).

2. The fluid transfer system (10) according to claim 1, further comprising a bag (26) located in said chamber (12).

3. The fluid transfer system (10) according to claim 2, wherein said bag (26) has a port (38) that extends in a sealed manner through said chamber (12).

4. The fluid transfer system (10) according to claim 3, wherein said port (38) is connected to a fluid connector (40) which is in fluid communication with a vial adaptor (50) connected to a vial (45).

5. The fluid transfer system (10) according to claim 4, further comprising another sensor (72) configured to sense a weight of contents of said vial (45).

6. The fluid transfer system (10) according to claim 5, further comprising a vial manipulator (56) configured to rotate said vial (45) from an upright position to an inverted position.

7. The fluid transfer system (10) according to claim 1, further comprising a pressure sensor (24) coupled to said pump (16).

8. A method of using the fluid transfer system (10) of claim 6, comprising:
connecting said fluid connector (40) with a tubing (46) to said bag (26), and inserting said bag (26) in an inner sleeve (30) of said chamber (12);
connecting said bag (26) to a bag bleeding membrane kit (44);
connecting said valve (48) to said vial adaptor (50), and connecting said vial adaptor (50) to said vial (45) and said vial manipulator (56); and
priming said inner sleeve (30) to expel all air out of said inner sleeve (30).

9. The method according to claim 8, further comprising reconstituting a substance contained in said vial (45) by opening said valve (48) and pumping liquid (28) from said bag (26) by using said pump (16) to pump fluid (14) from said reservoir (18) to said chamber (12), thereby squeezing said bag (26) to cause the liquid (28) to flow to said vial (45).

10. The method according to claim 8, further comprising drawing a liquid substance (59) contained in said vial (45) from said vial (45) to said bag (26), by inverting said vial (45) with said vial manipulator (56), opening said valve (48) and pumping fluid (14) from said chamber (12) to said reservoir (18) by using said pump (16), thereby causing said liquid substance (59) to flow from said vial (45) to said bag (26).
